(19) United States
(12) Patent Application Publication
(10) Pub. No.: US 2026/0094531 A1
(43) Pub. Date: Apr. 2, 2026

(54) REAL-TIME URGENCY DETECTION IN VIRTUAL LEARNING ENVIRONMENT

(71) Applicant: Lenovo (United States) Inc., Morrisville, NC (US)

(72) Inventors: Joshua Smith, Morrisville, NC (US); Tyler Nicholls, Morrisville, NC (US); Richard Downey, Morrisville, NC (US); Justin Miller, Morrisville, NC (US)

(21) Appl. No.: 18/903,923

(22) Filed: Oct. 1, 2024

(51) Int. Cl. G09B 5/14; G06F 40/205

(52) U.S. Cl. CPC G09B 5/14; G06F 40/205

(57) ABSTRACT

In one aspect, an apparatus includes a processor system and storage with instructions executable to receive first data and second data through a virtual learning platform. The first data is associated with a first student, and the second data is associated with a second student. The instructions are also executable to parse the first and second data to identify an order in which an instructor should virtually address the first and second students. Based on identifying the order, the instructions are also executable to present an indication of the order on a graphical user interface (GUI) through which the instructor monitors the first and second students using the virtual learning platform.

### FIELD

The disclosure below relates to technically inventive, non-routine solutions that are necessarily rooted in computer technology and that produce concrete technical improvements. In particular, the disclosure below relates to techniques for real-time urgency detection in virtual learning environments.

### BACKGROUND

As recognized herein, remote learning presents a unique set of issues that in-person learning does not. As further recognized herein, among these issues is that it is technologically difficult if not impossible to adequately track whether remote learning students are on track or in need of help (and to what degree help is needed). There are currently no adequate solutions to the foregoing computer-related, technological problem.

### SUMMARY

Accordingly, in one aspect an apparatus includes a processor system and storage accessible to the processor system. The storage includes instructions executable by the processor system to receive first data and second data through a remote learning platform. The first data is associated with a first student, and the second data is associated with a second student different from the first student. The instructions are also executable to parse the first and second data to identify an order in which an instructor should virtually address the first and second students. Based on identifying the order, the instructions are further executable to present an indication of the order on a graphical user interface (GUI) through which the instructor monitors the first and second students using the remote learning platform.

In some example implementations, the first data may include a first message sent to the instructor by the first student via the remote learning platform, and the second data may include a second message sent to the instructor by the second student via the remote learning platform. So here, parsing the first and second data may include processing the first and second data using natural language processing (NLP). In one specific instance, the instructions may be executable to execute NLP to identify a first sentiment of the first message and to identify a second sentiment of the second message, and then to identify the order based on the first sentiment being assigned a higher priority than the second sentiment. Additionally or alternatively, the instructions may be executable to identify a first keyword indicated in the first message and to identify a second keyword indicated in the second message, and then to identify the order based on the first keyword being assigned a higher priority than the second keyword.

Also in an example embodiment, the instructions may be executable to identify a digital hand raise of the first student, and then to identify the order based on the identification of the digital hand raise of the first student.

Further, in one example implementation, the instructions may also be executable to identify a first amount of time that the first student takes to perform a first task associated with a class instructed by the instructor, and to identify a second amount of time that the second student takes to perform a second task associated with the class. The instructions may then be executable to identify the order based on the identification of the first amount of time being longer than the second amount of time and/or the first amount of time exceeding a threshold amount of time.

What’s more, in some instances the instructions may be executable to identify a client device of the first student attempting to access a blocked website, and then to identify the order based on the identification of the client device of the first student attempting to access the blocked website.

In one example embodiment, the indication of the order may include an ordered listing of the first and second students according to a priority for the instructor to virtually address the first and second students. Additionally or alternatively, the indication of the order may include highlighting a first graphical element associated with the first student as presented at a client device of the instructor but not highlighting a second graphical element associated with the second student as concurrently presented at the client device of the instructor.

In another aspect, a method includes receiving first data and second data through a virtual learning platform, with the first data associated with a first student and the second data associated with a second student different from the first student. The method also includes parsing the first and second data to identify an order in which an instructor should virtually address the first and second students. Based on identifying the order, the method includes presenting an indication of the order at a client device through which the instructor monitors the first and second students using the virtual learning platform.

In one example, the first data may include a first message sent to the instructor by the first student via the virtual learning platform. Here the method may include executing natural language processing (NLP) to identify a first sentiment of the first message, and then identifying the order based on the first sentiment.

Also, if desired, the method may include identifying a digital hand raise of the first student, and then identifying the order based on the identification of the digital hand raise of the first student.

Also in one example implementation, the method may include identifying a first amount of time that the first student takes to perform a first task associated with a class instructed by the instructor, and then identifying the order based on the identification the first amount of time. Additionally or alternatively, the method may include tracking Internet browser data for a client device of the first student, and then identifying the order based on the tracking of the Internet browser data for the client device of the first student.

In still another aspect, at least one computer readable storage medium (CRSM) that is not a transitory signal includes instructions executable by a processor system to receive first data through a virtual learning platform. The first data is associated with a first student. The instructions are also executable to parse the first data to identify an order in which an instructor should virtually address the first student and a second student different from the first student. The instructions are also executable to, based on identifying the order, present an indication of the order at a client device of a class instructor.

In one example, the first data may include a first message sent to the instructor by the first student.

Also in one example, the instructions may be executable to identify a first sentiment of the first message, and to identify the order based on the first sentiment.

Still further, in some implementations, the instructions may be executable to identify a negative sentiment of the first student, and to arrange the order to indicate that the first student has priority over the second student based on the identification of the negative sentiment.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 shows an example graphical user interface (GUI) that may be presented at an instructor’s client device to indicate an order in which an instructor should virtually address students during a live online class session consistent with present principles;

FIG. 4 shows a schematic diagram of data, models, and processes according to one example implementation of present principles;

FIG. 5 illustrates example logic in example flow chart format that may be executed by a device consistent with present principles;

FIG. 6 illustrates example software architecture that may be implemented consistent with present principles; and

FIG. 7 shows an example GUI that may be presented to configure one or more settings of a device, app, and/or platform to operate consistent with present principles.

### DETAILED DESCRIPTION

Among other things, the detailed description below discusses technical improvements to computer technology to address student needs in a virtual learning environment, where those students might each have different needs to address. Some students may have questions about the class content, others may be wondering about their grades, others may need to use the restroom, and still others may need other support. Accordingly, a virtual learning platform such as Lenovo’s LanschoolAir may be used with the technical improvements set forth herein to process the state of the classroom using the data on the platform. A mixture of urgency detection through NLP and tabular classification may therefore be used to determine a student’s need for assistance in non-limiting embodiments.

Furthermore, based on feedback from the teachers, the platform may also continuously learn to be more accurate via reinforcement learning.

Thus, in one example the platform may process multiple data points from an online classroom to classify which students could use assistance first before others. Various data points can be used by the prioritization model, including keywords in messages, sentiment of messages, the current task students are working on and if the student is on (or off) task, the estimated time required to complete the student’s request, if the student is raising their virtual hand or not, if the student is trying to access a blocked website, etc. The platform may also analyze the state of all students in the class to determine each student’s expected need for assistance. The technological improvements advanced herein can thus be used by teachers to prioritize which students need immediate help. For example, messages containing words such as “emergency,” “help,” or expressing negative emotion may be classified as high priority, while other more general inquiries may be classified as low priority.

One example implementation even includes highlighting student cards in the UI (presented to the instructor) based on the urgency of helping that student.

Accordingly, in one specific example for the platform to calculate a student’s need for assistance, the data used by the platform may be processed in a two-step process. The first step may take students’ messages and perform NLP with them to determine a metric for the students’ need for assistance based on text only. A foundational model can be fine-tuned for this use case, and/or a dedicated model may be trained from scratch. Either way, the output from this model may then be used at a second step in combination with the remaining data points being used as inputs for a separately-trained tabular classification model. The tabular classification model may be trained from scratch to improve accuracy. Beyond that, the platform may use reinforcement learning to fine-tune the model to the tastes of specific teachers or organizations.

Also as one specific example, suppose a class objective has been set by the teacher and several students are determined as “off-task.” Those that have been off-task the longest are determined as the ones that need the support the soonest. Students who ask questions about the content are determined to need help sooner than those asking questions about non-education-related topics. Students who ask explicitly for help may be supported first, and students who need help but who aren’t asking for it explicitly should also be helped lower in the priority chain set by the platform. Students who are on non-educational websites can be noted as “off-task” and therefore assigned a higher priority for assistance, and students who are on educational websites but stuck for more than a “reasonable” amount of time as determined by the platform may be identified as “off-task” for the teacher to prioritize them as well.

Accordingly, students asking for explicit help, and students needing help implicitly, may be prioritized based on severity. Stronger explicit words in chat, or longer times stuck on a webpage, are examples of variables that may be used to determine the appropriate prioritization.

Thus, using the improvements to computer technology set forth herein, teachers will be able to more efficiently help students in virtual learning environments by being able to identify the most urgent needs quickly to respond. Through the computer improvements set forth herein, teachers save time that can then be used for further educating their students. Students can benefit from this too since they receive more timely attention from their teachers based on the technological improvements advanced herein. This overall improves student engagement since the timely responses will make students feel more valued and supported while educating them in a more effective manner.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java^{®}/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein.

"A system having at least one of A, B, and C" (likewise "a system having at least one of A, B, or C" and "a system having at least one of A, B, C") includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

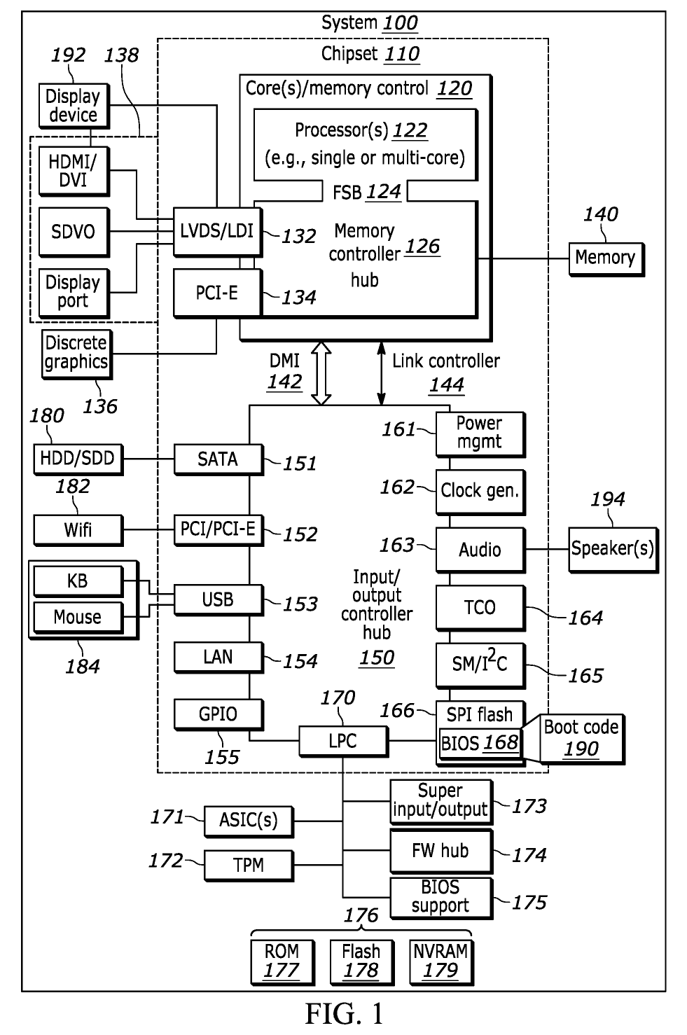

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

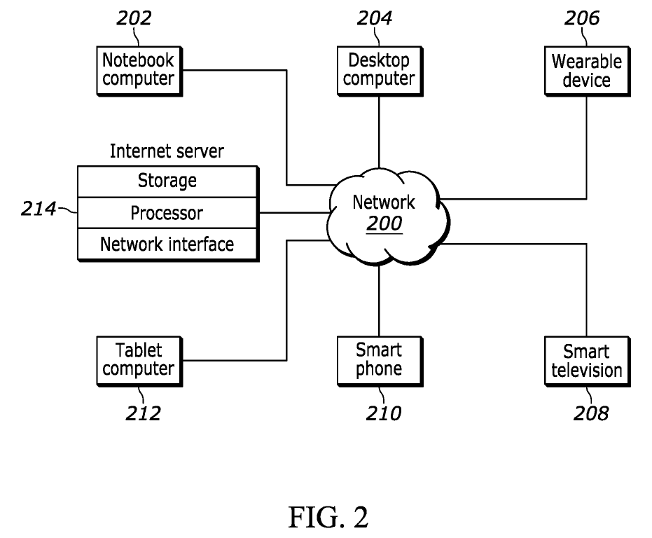

Turning now to FIG. 2, example devices are shown communicating over a network 200 such as the Internet in accordance with present principles (e.g., for participation in a virtual-learning environment hosted by a server). It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

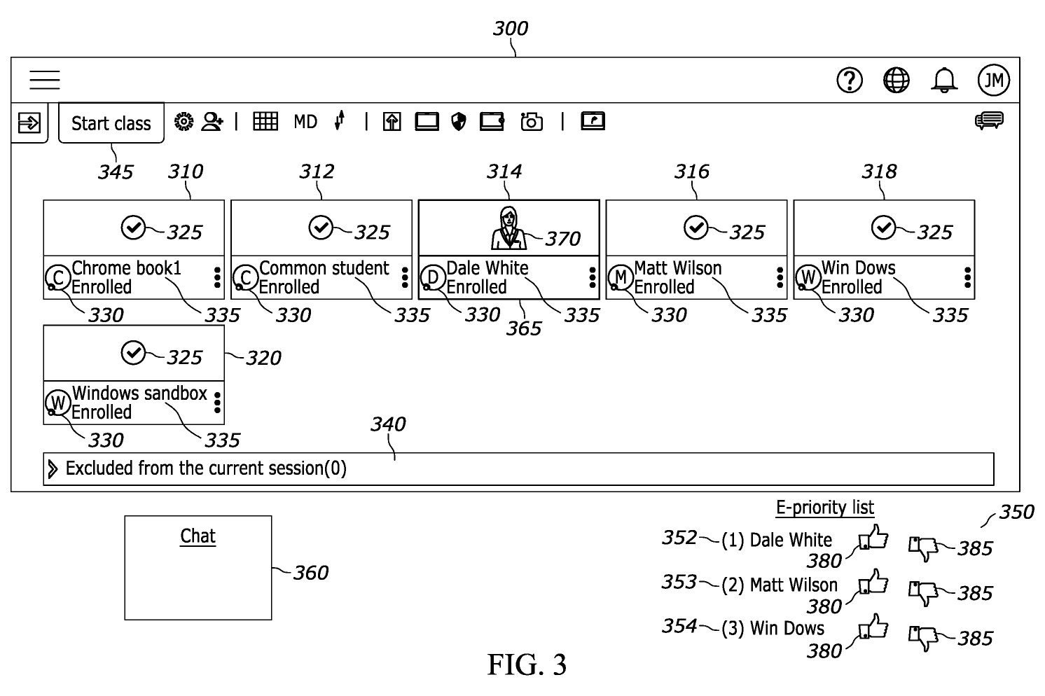

Now in reference to FIG. 3, suppose a teacher or other instructor is instructing a class of students through a virtual learning platform, which may be used for remote virtual learning where each student is located at his/her personal residence or other different location from the other students. The platform may also be used for in-class virtual learning in combination with live in-person class time in the classroom itself according to a hybrid learning environment (e.g., each student having their own client device to connect to the platform from the classroom as well as their personal residence). In various examples, the class itself may be a K-12 class, an undergraduate-level class, a graduate-level class, a vocational class, etc. In one particular example, the platform itself may be Lenovo’s LanSchoolAir platform, though other platforms may also be used consistent with present principles.

Also suppose that as part of the virtual learning, the instructor is monitoring the progress of different students in the class as they participate in the class online through the platform, whether that is to send electronic messages to the instructor, perform designated class tasks through the platform, etc. To monitor the students, the instructor may therefore launch an instance of the platform’s application (“app”) at the instructor’s own client device, login through a web portal for the platform, or otherwise access the platform itself for the instructor’s client device to then present the graphical user interface (GUI) 300 shown in FIG. 3.

The GUI 300 may include cards 310-320 associated with respective human students of the class that are each connected/logged in live in real time through a respective app instance executing at their own respective client device. The cards 310-320 are but examples, and other graphical elements associated with each the student may additionally or alternatively be used, such as student profile pictures, avatars, etc. In any case, as may be appreciated from FIG. 3, each card 310-320 may include a respective green check mark 325 to indicate that the student is connected live to the class through the platform, and may also include a respective name initial icon 330 and first and last name indication 335 as expressed in text.

In some examples, the GUI 300 may also include a drop-down selector 340 that the instructor may select to command the platform to present a listing of students that are not currently logged in live to the platform and/or the current virtual class session in particular. Further note that a “start class” selector 345 may be selected at the appropriate time for the instructor to begin a live, online verbal class instruction where the instructor’s local audio and video are streamed to the client devices of the students through the platform for the students to watch and listen to the instructor instruct the class.

However, for the present example, assume instead that live class instruction is not currently transpiring but that the students are independently working on class assignments through the platform while the teacher monitors them via the GUI 300. Also suppose consistent with present principles that the platform has identified one or more of the students as needing assistance through various technological processes set forth in greater detail below.

Based on the identification(s), an “E-Priority List” 350 may be presented as part of the GUI 300, with the list 350 establishing an ordered listing of students that the instructor should virtually address in order according to a priority set by the platform. As shown in FIG. 3, in the present example, priority is listed in ascending order from one to two to three and so on, with each entry in the list 350 establishing a selector 352-354 with a respective name of the respective student on the face of the selector 352-354. Each selector 352-354 may be selectable to open a direct live line of communication between the instructor and respective students (while keeping the line of communication closed to others so that the line of communication is not available to other students in the class for privacy reasons, to not disturb the other students while they work online, etc.).

The direct line of communication may be an audio line of communication where the student and instructor can audibly converse with each other through live audio streams using respective speakers and microphones at each client device. Additionally or alternatively, the direct line of communication may be a video line of communication where both audio and video of the student and instructor are streamed to the other person’s client device live in real time using cameras and displays at the respective client devices (in addition to the microphones and speakers for audio as mentioned above). Still further, the direct line of communication may include live text-based chat communication, where text-based electronic messages are exchanged between the two people via the chat box 360, via email, etc.

Also per FIG. 3, note that a first student named “Dale White” has been assigned the highest priority for the instructor to address that student first before addressing other students also included in the list 350. Responsive to platform determining that Dale has the highest priority, the GUI 300 may dynamically update to highlight Dale’s card 314 (or other graphical element assigned to Dale as presented on the GUI 300). Dale’s card 314 may be highlighted with a red border 365 to draw the instructor’s attention to Dale as the student with the highest priority for immediate virtual assistance. Note that no other students may be concurrently highlighted on the GUI 300 to make it easier for the instructor to quickly identify Dale as being in need of virtual assistance. Or in other examples, multiple students indicated on the list 350 may have their respective cards highlighted, with the highlighting of each card 310-320 being color-coded based on the students’ order in the list 350 and/or an assigned overall level of priority (e.g., from critical to intermediate to low).

So in examples where various cards 310-320 are highlighted with color coding based on the students’ order in the list 350, the highest-priority student may be color-coded red, the next (second) highest-priority student may be color-coded yellow, and the next (third) highest-priority student may be color-coded green. In examples where the various cards 310-320 are highlighted with color coding based on the assigned overall level of priority determined by the platform, students with a critical level of priority may have their cards coded red, students with an intermediate level of priority may have their cards coded yellow, and students with a low level of priority may have their cards coded green.

Also responsive to determining that Dale has been assigned the highest priority for the instructor to address before other students also included in the list 350, the platform may animate Dale’s card 314 to change from the static green check mark 325 to presenting a live video feed 370 of Dale’s face and/or Dale’s active display screen (e.g., video with or without audio). Thus, the video 370 may be sourced from a camera at Dale’s client device that captures Dale’s face in real time, and/or may be sourced from screen monitoring software, respectively. Either way, the video 370 may help the instructor determine if Dale is really in need of virtual assistance through the platform.

However, note that in still other examples, the live video feed of each student listed in the list 350 may be presented on their respective card 310-320 in place of their respective green check mark 325 (with the mark 325 otherwise indicating the respective student as being on task and not in need of virtual assistance as determined by the platform).

Additionally or alternatively, further note that the video 370 of Dale’s face or screen (or that of another student) may be presented as the aforementioned video that gets presented responsive to selection of the selector 352 itself.

It may therefore be appreciated based on the foregoing that the instructor may advantageously cycle through the students the platform has identified as being in need of virtual assistance. However, the platform may also monitor the instructor’s inputs to the GUI 300 and the instructor’s workflow in virtually addressing each student noted in the list 350 to then determine if the platform incorrectly established the priority. This may be done so that the platform can subsequently perform machine learning to further train the model to make priority inferences with higher accuracy in the future.

Thus, machine learning such as reinforcement learning may be executed based on inputs from the instructor to the GUI 300, such as input to a respective “thumbs up” selector 380 or “thumbs down” selector 385. The instructor may select either selector 380, 385 before or after engaging the respective student themselves. The thumbs up selector 380 may be selected to indicate to the platform that the priority selection for the respective student was correct/acceptable, while the thumbs down selector 385 may be selected to indicate to the platform that the priority selection for the respective student was incorrect/not acceptable.

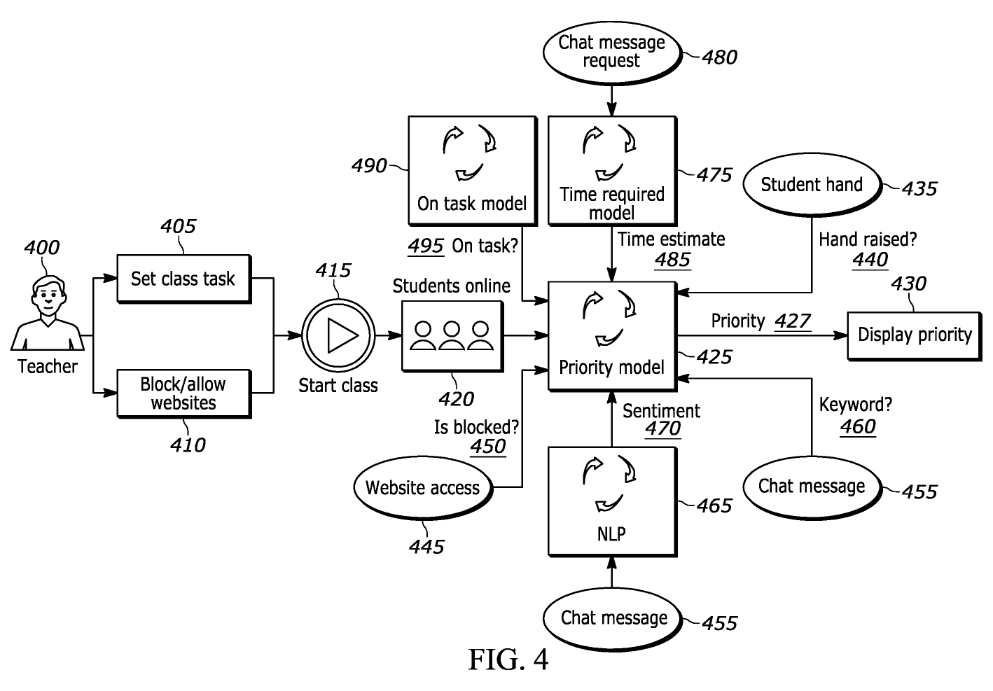

FIG. 4 is a schematic diagram that further illustrates present principles. As shown, through an online learning platform, a class instructor 400 may set a class task 405 in the platform, and also block and allow access to various websites 410 at the student client devices while those devices are logged into the platform. At step 415 the instructor 400 may then initiate an online/virtual session for the class, linking all the students into the class online 420 through the platform. Then, while the students embark on tasks for the class individually or in groups (the task itself for each student/group being the same or different), the platform may monitor incoming data related to each student using a priority model 425. The model 425 may be executed consistent with present principles to establish an order of priority for the instructor to render virtual assistance or otherwise address the students in the order of priority through the platform.

As shown in FIG. 4, various different kinds of inputs/data may be received and processed by the model 425 to ultimately determine the order of priority 427 and present the priority 427 at the instructor’s client device at step 430.

For example, a digital hand raise 435 submitted to the platform by a first student as determined 440 by the model 425 may be used to identify the order of priority (at least in part). The digital hand raise may have been initiated by the first student through their own respective online class GUI presented through their own app instance for the platform, with the student selecting a “hand raise” selector for the platform to then present an icon of a hand raise gesture on the GUI 300 of the instructor’s device over top of the first student’s card.

Another type of input to the model 425 may be website access data or other Internet browser data 445 from the respective client devices of the students, with the data being for websites and other Internet activity occurring during the same timespan as the live virtual class session itself. This data may then be used by the model 425 to infer whether the respective student is on-track in performing the class assignment (or not). In one specific example, the platform may use the data 445 to track the Internet browser activity of the student and identify 450 the respective student as attempting to access a blocked website through that student’s client device. The model 425 may then then identify the order based on the identification of the student attempting to access the blocked website, with present principles recognizing that this may indicate that the respective student is off-track in the assignment as the student is attempting to access blocked websites 410 rather than allowed websites 410.

As yet another example type of input to the model 425, the model 425 may receive text-based chat messages 455 submitted through the platform by one or more students. In one particular example, the model 425 may then identify a first keyword indicated in a first message from a first student, identify a second keyword indicated in a second message a second student, and so on. From this data 455 the model 45 may then identify the order based on the first keyword being assigned a higher priority than the second keyword. For example, certain predefined words like “help”, “assistance”, “confused”, etc. may be preprogrammed into the platform as having the highest priority so that any message containing one of those words is assigned a higher priority (and hence so is the student) than messages containing other words that are not keywords.

FIG. 4 also shows that the chat messages 455 may be input to a natural language processing (NLP) model 465. The messages 455 may therefore be parsed using one or more NLP algorithms for the model 465 to infer a sentiment 470 that is then fed into the model 425 for the model 425 to determine the order based on the sentiment (e.g., at least in part). In one particular non-limiting embodiment, NLP may be executed to identify a first sentiment of the first message mentioned above, and to identify a second sentiment of the second message mention above. The platform may then identify the order based on the first sentiment being assigned a higher priority than the second sentiment. For example, predefined sentiments of frustration, confusion, anger, sadness, and/or other negative sentiment may be preprogrammed into the platform as having the highest priority so that any message expressing one of those sentiments is assigned a higher priority (and hence so is the student) than messages containing other identified sentiments such as messages expressing positive sentiment(s).

Still in reference to FIG. 4, the schematic also shows that a time required model 475 may also be executed to provide input to the model 425. The time required model 475 may identify the estimated time required by the instructor to address each student virtually. The complexity of a question asked by a respective student in a respective message 455 may therefore be considered, as well as other inputs to the system such as sentiment severity and amount of the student’s own task left to be completed within the prescribed time. Students whose time-to-answer estimates are lower than others may be prioritized above those students for which more time will be required of the instructor to address that student’s needs.

The model 475 may perform other functions as well. For example, the model 475 may determine a first amount of time that the first student takes to perform a first task associated with the class, identify a second amount of time that the second student takes to perform a second task associated with the class, and so on. Those times may then be fed into the model 425 for the model 425 to identify an order of priority based on the times. For example, the first amount of time being longer than the second amount of time may result in the first student being assigned a higher priority over the second student. As another example, the first amount of time (or any amount of time for any student) exceeding a threshold amount of time may result in the associated student being assigned a higher priority over other students for which their time data does not satisfy the threshold.

As also shown in FIG. 4, the platform may include an on-task model 490 to determine 495 whether a respective student is on-task in completing their assignment based on client device and app data associated with that student as provided by that student’s client device. For example, topic modeling may be executed to determine if a current, active website presented at the client device relates to the topic of the class-related task. The content of other apps launched and active at the student’s client device may be similarly parsed to make the determination. Messaging account activity for connected devices may also be parsed, such as if the same student is using a separate smartphone to send short message service (SMS) or multimedia message service (MMS) cellular messages from the smartphone. Internet-based messages may also be monitored, such as those sent via WhatsApp, Signal, email, etc.

Before moving on to the description of other figures, note with respect to FIG. 4 that in some examples, a large language model (LLM) may be used to execute some or all of the functions of the other models discussed above. However, the distinct, discrete, lighter-weight models discussed above may provide technological advantages in certain non-limiting instances in that LLMs can be computationally heavy to run, while the smaller models above as tailored to the specific tasks mentioned above may result in quicker outputs using less processing resources and energy.

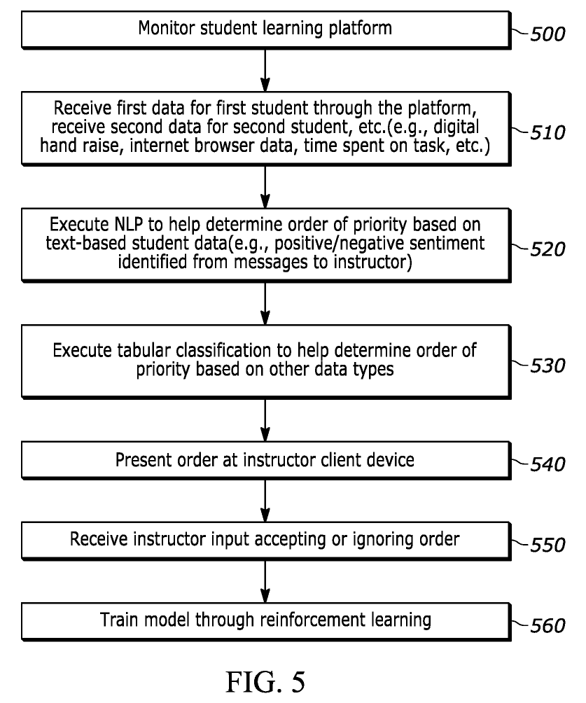

Referring now to FIG. 5, it shows example logic that may be executed by an apparatus such as the system 100 and/or a coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 5 is shown in flow chart format, other suitable logic may also be used (e.g., state machine).

Beginning at block 500, the apparatus may monitor inputs to a virtual learning platform as described herein. For example, at block 510 the apparatus may receive first data and second data through the virtual learning platform, with the first data being associated with a first student and the second data being associated with a second student different from the first student. The first and second data may indicate digital hand raises , Internet browser activity, time spent on a task, etc. as mentioned above.

The apparatus may then parse the first and second data to identify an order in which an instructor should virtually address the first and second students. Thus, at block 520 the apparatus might execute NLP to help determine the order of priority based on text-based student data, including messages sent from the respective student to the class’s instructor. The logic may then proceed to block 530 where the apparatus may execute a tabular classification model to help determine the order of priority based on other types of non-text data, such as digital hand raises, sentiments identified from the text-based data itself, blocked website access attempts, etc.

After block 530 the logic may then proceed to block 540. At block 540, based on identifying the order of priority, the apparatus may present an indication of the order at an instructor client device, such as on via GUI like the GUI 300 through which the instructor monitors the first and second students using the remote learning platform.

After block 540 the logic may proceed to block 550. At block 550 the apparatus may receive instructor input accepting or ignoring the order when virtually addressing the students themselves. For example, feedback on the order being correct may be received based on the instructor selecting one or more of the thumbs up selectors 380 described above, while feedback on the order being incorrect may be received based on the instructor selecting one or more of the thumbs down selectors 385 described above. Those inputs may then be used at block 560 to train one or more models, such as the model 425, through reinforcement learning and other machine learning techniques to make better order of priority inferences in the future.

Other types of feedback may also be received at block 550. For example, the platform may monitor the instructor’s communications with the students to determine if the instructor virtually addresses the students in a different order over time than the order output by the platform, which may then be used to infer that the order provided by the platform was incorrect. The actual order used by the instructor may then be used as training data at block 560 to train the model through reinforcement learning and other machine learning techniques to make better order of priority inferences in the future.

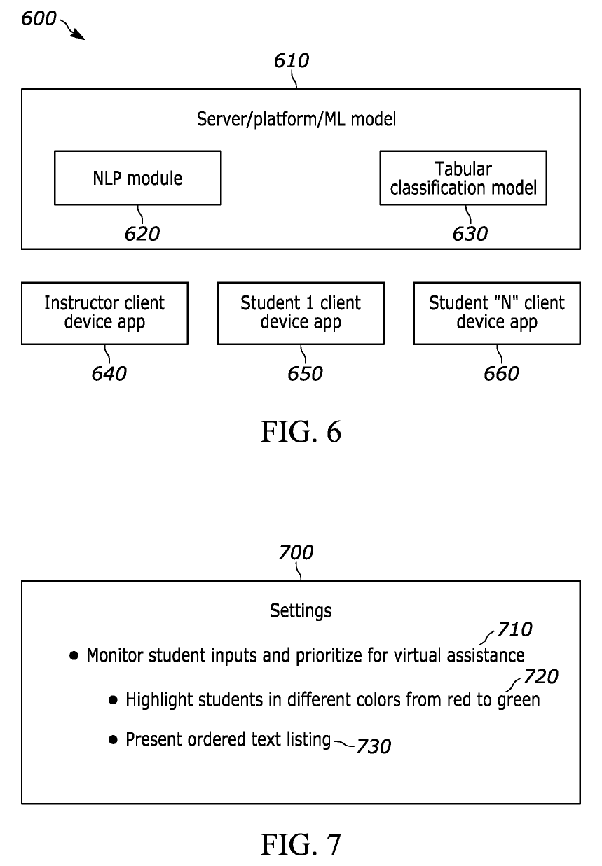

Now in reference to FIG. 6, example software architecture 600 is shown that may be implemented consistent with present principles. However, present principles are not limited to the architecture 600 of FIG. 6 as other configurations are also encompassed by present principles.

In any case, as shown in FIG. 6, a server 610 may have one or more software components residing on it, including those for execution of a virtual learning platform and/or machine learning model hosted by the server 610 consistent with present principles. Thus, the software components on the server 610 may include an NLP module 620 with NLP capability according to the description above, and a tabular classification model 630 according to the description above.

FIG. 6 also shows that one or more client-side applications (“apps”) for the same platform may be executed at respective client devices 640-660, with the devices 640-660 being in communication with the server 610 over the Internet or another network to undertake present principles. Thus, an instance of the app unique to class instructors may be executed at the instructor client device 640 to present the GUI 300 of FIG. 3. Two other end-user instances of the app for the class’s students may be executed at the student client devices 650, 660 to provide different types of student data, including but not limited to those described above in reference to FIG. 4.

Continuing the detailed description in reference to FIG. 7, it shows an example GUI 700 that may be presented on a display for an end-user to configure one or more settings of an apparatus, software application (“app”), and/or virtual learning platform to operate consistent with present principles. Each option discussed below may be selected by selecting the respective radio button shown adjacent to each option, whether through cursor input, touch input, or another type of input.

As shown in FIG. 7, the GUI 700 may include an option 710 that is selectable to set or configure the platform to undertake present principles. Therefore, in one example, selection of the option 710 a single time may configure the device to, for multiple future instances (e.g., different virtual learning sessions), execute the functions described above in reference to FIGS. 3-6. The option 710 may be accompanied by one or more sub-options 720, 730. Each sub-option may configure the platform to present an indication of an order of priority through a different technique.

Thus, selection of the sub-option 720 may set or configure the platform to highlight students in different colors from red to green as described above. Sub-option 730 may be selected to set or configure the platform to indicate an order of priority through an ordered text listing as also described above. The sub-options 720, 730 are being provided as examples and other ways to indicate the order or priority are also encompassed by present principles and may be presented as its own respective option.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principals have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. An apparatus, comprising:
a processor system; and
storage accessible to the processor system and comprising instructions executable by the processor system to:
receive first data and second data through a remote learning platform, the first data associated with a first student and the second data associated with a second student different from the first student;
parse the first and second data to identify an order in which an instructor should virtually address the first and second students; and
based on identifying the order, present an indication of the order on a graphical user interface (GUI) through which the instructor monitors the first and second students using the remote learning platform.

2. The apparatus of claim 1, wherein the first data comprises a first message sent to the instructor by the first student via the remote learning platform, and wherein the second data comprises a second message sent to the instructor by the second student via the remote learning platform.

3. The apparatus of claim 2, wherein parsing the first and second data comprises processing the first and second data using natural language processing (NLP).

4. The apparatus of claim 3, wherein the instructions are executable to:
execute NLP to identify a first sentiment of the first message and to identify a second sentiment of the second message; and
identify the order based on the first sentiment being assigned a higher priority than the second sentiment.

5. The apparatus of claim 2, wherein the instructions are executable to:
identify a first keyword indicated in the first message and identify a second keyword indicated in the second message; and
identify the order based on the first keyword being assigned a higher priority than the second keyword.

6. The apparatus of claim 1, wherein the instructions are executable to:
identify a digital hand raise of the first student; and
identify the order based on the identification of the digital hand raise of the first student.

7. The apparatus of claim 1, wherein the instructions are executable to:
identify a first amount of time that the first student takes to perform a first task associated with a class instructed by the instructor;
identify a second amount of time that the second student takes to perform a second task associated with the class; and
identify the order based on the identification of: the first amount of time being longer than the second amount of time, and/or the first amount of time exceeding a threshold amount of time.

8. The apparatus of claim 1, wherein the instructions are executable to:
identify a client device of the first student attempting to access a blocked website; and
identify the order based on the identification of the client device of the first student attempting to access the blocked website.

9. The apparatus of claim 1, wherein the indication of the order comprises an ordered listing of the first and second students according to a priority for the instructor to virtually address the first and second students.

10. The apparatus of claim 1, wherein the indication of the order comprises: highlighting a first graphical element associated with the first student as presented at a client device of the instructor but not highlighting a second graphical element associated with the second student as concurrently presented at the client device of the instructor.

11. A method, comprising:
receiving first data and second data through a virtual learning platform, the first data associated with a first student and the second data associated with a second student different from the first student;
parsing the first and second data to identify an order in which an instructor should virtually address the first and second students; and
based on identifying the order, presenting an indication of the order at a client device through which the instructor monitors the first and second students using the virtual learning platform.

12. The method of claim 11, wherein the first data comprises a first message sent to the instructor by the first student via the virtual learning platform.

13. The method of claim 12, comprising:
executing natural language processing (NLP) to identify a first sentiment of the first message; and
identifying the order based on the first sentiment.

14. The method of claim 11, comprising:
identifying a digital hand raise of the first student; and
identifying the order based on the identification of the digital hand raise of the first student.

15. The method of claim 11, comprising:
identifying a first amount of time that the first student takes to perform a first task associated with a class instructed by the instructor; and
identifying the order based on the identification the first amount of time.

16. The method of claim 11, comprising:
tracking Internet browser data for a client device of the first student; and
identifying the order based on the tracking of the Internet browser data for the client device of the first student.

17. At least one computer readable storage medium (CRSM) that is not a transitory signal, the at least one CRSM comprising instructions executable by a processor system to:
receive first data through a virtual learning platform, the first data associated with a first student;
parse the first data to identify an order in which an instructor should virtually address the first student and a second student different from the first student; and
based on identifying the order, present an indication of the order at a client device of a class instructor.

18. The at least one CRSM of claim 17, wherein the first data comprises a first message sent to the instructor by the first student.

19. The at least one CRSM of claim 18, wherein the instructions are executable to:
identify a first sentiment of the first message; and
identify the order based on the first sentiment.

20. The at least one CRSM of claim 17, wherein the instructions are executable to:
identify a negative sentiment of the first student; and
based on the identification of the negative sentiment, arrange the order to indicate that the first student has priority over the second student.
